(19) United States
(12) Patent Application Publication
(10) Pub. No.: US 2022/0044271 A1
(43) Pub. Date: Feb. 10, 2022

(54) OPTIMIZATION ENGINE FOR FULFILLING A CUSTOMER ORDER FROM MULTIPLE VENDORS USING ONE OR MORE OPTIMIZATION CRITERIA

(71) Applicant: Wisful Investments, LLC., Los Angeles, CA (US)

(72) Inventors: William-Kofi ADOFO, Beverly Hills, CA (US); Adrian PETTER, Los Angeles, CA (US)

(21) Appl. No.: 17/393,117

(22) Filed: Aug. 3, 2021

Related U.S. Application Data
(60) Provisional application No. 63/061,088, filed on Aug. 4, 2020.

(51) Int. Cl. G06Q 30/02; G06Q 30/06

(52) U.S. Cl. CPC G06Q 30/0222; G06Q 30/0633; G06Q 30/0639; G06Q 30/0239

(57) ABSTRACT

A computer-implemented optimization engine is disclosed for fulfilling a user order from multiple vendors using one or more optimization criteria. The optimization criteria can include price, brand, and acquisition time. The optimization engine obtains from a plurality of servers item price data and logistics cost data for stores physically in proximity to the user, or optionally, for stores that can ship items to the user from locations that are not physically in proximity to the user. The optimization engine optionally generates user preference data for the user based on his or her orders, where the user preference data indicates the user's sensitivity to changes in price, brand, and acquisition time.

### PRIORITY CLAIM

This application claims priority from U.S. Provisional Patent Application No. 63/061,088, filed on Aug. 4, 2020, and titled, “Optimization Engine,” which is incorporated by reference herein.

### FIELD OF THE INVENTION

A computer-implemented optimization engine is disclosed for fulfilling a user order from multiple vendors using one or more optimization criteria.

### BACKGROUND OF THE INVENTION

A typical consumer has a list of items which they buy every year. Each item can be ranked by importance in an individual or collective cost-benefit model.

The theory is simple: For maximum “Satisfaction” (S), the consumer must maximize their “Benefit” (B) and lower their “Cost” (C), which can be expressed as:

S=B−C

Benefit (B) is usually measured by how much a customer wants or needs a product. Cost (C) may be defined in many ways, from the actual price of an item to the logistical cost (in either price or time) it takes to acquire an item. Logistical costs are typically accounted for in procurement by delivery fees, service fees or delivery time and convenience.

There are two important observations about buyer satisfaction:

Observation No. 1: If B is low, C must be low too.

If a buyer simply wants a snack, they will probably get one from a nearby seller. It may not be their absolute favorite snack, but it is most convenient to acquire. If it takes more time, effort or expenditure, the person may decide not to get the snack. This is because the Benefit is low, so to achieve Satisfaction, the Cost (of effort time or price) must also be low.

That is, S=B−C, so if B>C, then S is positive. If C>B, then S is negative, and the buyer will be dissatisfied. Thus, for a buyer to be satisfied, if B is low, C must be low also, and must be lower than B.

Observation No. 2: If B is high, then C can be high too.

A buyer may respond very differently for a product of a much higher Benefit. If a buyer needs to buy medicine, for example, or a car, the benefit is so high they will likely be willing to spend more time, money and effort.

Of course, the optimal scenario is to have maximum benefit at the lowest cost, that is, for B to be high and C to be low.

Because there are multiple factors to determine both Benefit and Cost, a more accurate equation for an unideal and nuanced world is:

Sₒ=Σ₀ⁿSₙ=Σ(b₁+b₂+. . . bₙ)−Σ(c₁+c₂+. . . cₙ)

Overall Satisfaction (So)=The sum of Satisfaction of every item purchased.

In the digital age, consumers purchase billions of hardware and software products online, with the hope of achieving maximum overall satisfaction. However even with the convenience of the internet, consumers cannot mentally calculate every single cost-benefit scenario and centralize it to one single transaction.

For example, goods purchased on the Internet require users to guess who and where is the best seller, and then make an internal calculation on the optimal choice in terms of price of the goods and logistics. Modern day search engines attempt to mitigate the user's task by providing one place in which every seller can be found, but it is still up to the user to calculate the time, place and priority to make an optimal purchase. In addition, sellers benefit from this ambiguity by hiding the cost of logistic, which the user pays via price mark ups, a separate fee, or a combination of both.

In another aspect of the modern marketplace, sellers try to position their products to incentivize customers to purchase their products by either blindly lowering cost (C) or blindly increasing the benefit (B). They do this for every customer because they cannot pinpoint their ideal buyer. Buyers in turn are bombarded with lower costs for items of low benefit or get higher benefit at much higher cost.

What is needed is a tool for optimizing the purchasing process for a user that is flexible enough to optimize based on different criteria, such as item type and brand, cost, and speed of product acquisition (for example, delivery time, download time, subscription time, etc.). What is further needed is tool for optimizing the selling process for a seller to assist that seller in finding its ideal buyer and to find other opportunities.

### SUMMARY OF THE INVENTION

A novel optimization engine is disclosed. The optimization engine can take a customer's list of Cost-Benefit needs and offer one transaction at maximum satisfaction (S), tailored to three main user sensitivities: product/brand loyalty (Benefit), price (Cost) and speed of acquisition (delivery time, convenience, etc.). The optimization engine offers three options which cater to benefit, cost, and time, and uses the buyer's decision to estimate what drives the buyer's satisfaction. It can learn and predict a customer's “satisfaction score” by calculating how many times a decision was made, based primarily on a factor of benefit or cost, and it does this for every singular or collective item.

A specific use case is described before for a user who wishes to purchase goods from nearby physical stores and warehouses. The optimization engine fulfills a user order from multiple vendors using one or more optimization criteria. The optimization criteria can include price, brand, and delivery time. The optimization engine obtains from a plurality of servers item price data and logistical/service price data for stores physically in proximity to the user, or optionally, for sellers stores that can ship items to the user from locations that are not physically in proximity to the user. The optimization engine optionally generates user preference data for the user based on his or her orders, where the user preference data indicates the user's sensitivity to changes in price, brand, and acquisition time. Simply put, the optimization engine is a product elasticity calculator that uses every customer's unique sensitivities to understand and predict an optimal purchase.

### BRIEF DESCRIPTION OF THE DRAWINGS

FIG. 1 depicts prior art hardware components of a client device.

FIG. 2 depicts software components of a client device.

FIG. 3 depicts prior art hardware components of a server.

FIG. 4 depicts software components of a server.

FIG. 5 depicts a client device interacting with a server.

FIGS. 6A and 6B depict optimization engines executed by a client device and a server.

FIG. 7 depicts an optimization method performed by an optimization engine,

FIG. 8 depicts an example of a preliminary matrix generated during the optimization method.

FIG. 9 depicts an example of a discounted item matrix generated during the optimization method.

FIG. 10 depicts an example of an alternative item matrix generated during the optimization method.

FIG. 11 depicts an example of a final matrix generated under the “Your Choice” sub-method.

FIG. 12 depicts an example of a final matrix generated under the “Super Savings” sub-method.

FIG. 13 depicts an example of a final matrix generated under the “Our Choice” sub-method.

FIG. 14 depicts an example of a preliminary matrix generated under the optimization method, where the user can select priority items and Internet items.

FIG. 15 depicts an example of a discounted item matrix generated under the optimization method, where the user has selected priority items and Internet items.

FIG. 16 depicts an example of a final matrix generated under the optimization method, where the user has selected priority items and Internet items.

FIG. 17 depicts an optimization algorithm performed by the optimization engine.

### DETAILED DESCRIPTION OF THE INVENTION

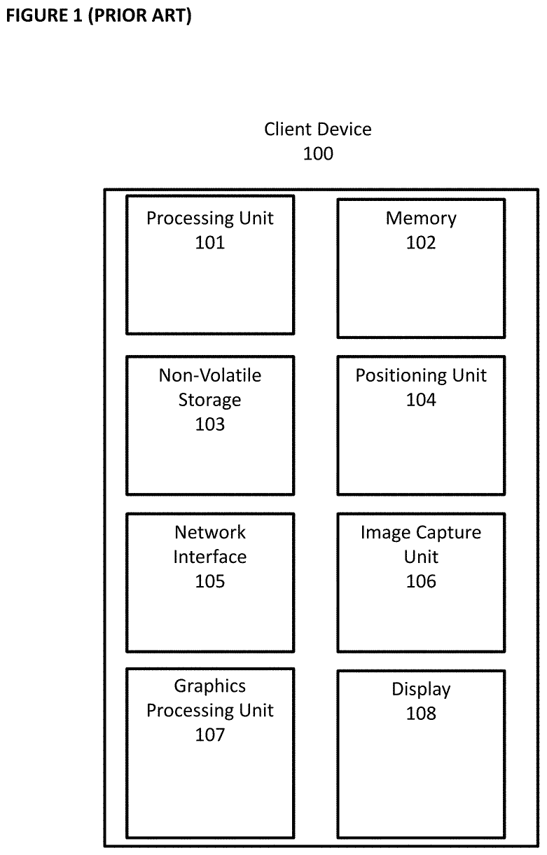

FIG. 1 depicts hardware components of client device 100. These hardware components are known in the prior art. Client device 100 is a computing device that comprises processing unit 101, memory 102, non-volatile storage 103, positioning unit 104, network interface 105, image capture unit 106, graphics processing unit 107, and display 108. Client device 100 can be a smartphone, notebook computer, tablet, desktop computer, gaming unit, wearable computing device such as a watch or glasses, or any other computing device.

Processing unit 101 optionally comprises a microprocessor with one or more processing cores. Memory 102 optionally comprises DRAM or SRAM volatile memory. Non-volatile storage 103 optionally comprises a hard disk drive or flash memory array. Positioning unit 104 optionally comprises a GPS unit or GNSS unit that communicates with GPS or GNSS satellites to determine latitude and longitude coordinates for client device 100, usually output as latitude data and longitude data. Network interface 105 optionally comprises a wired interface (e.g., Ethernet interface) or wireless interface (e.g., 3G, 4G, GSM, 802.11, protocol known by the trademark “Bluetooth,” etc.). Image capture unit 106 optionally comprises one or more standard cameras (as is currently found on most smartphones and notebook computers). Graphics processing unit 107 optionally comprises a controller or processor for generating graphics for display. Display 108 displays the graphics generated by graphics processing unit 107, and optionally comprises a monitor, touchscreen, or other type of display.

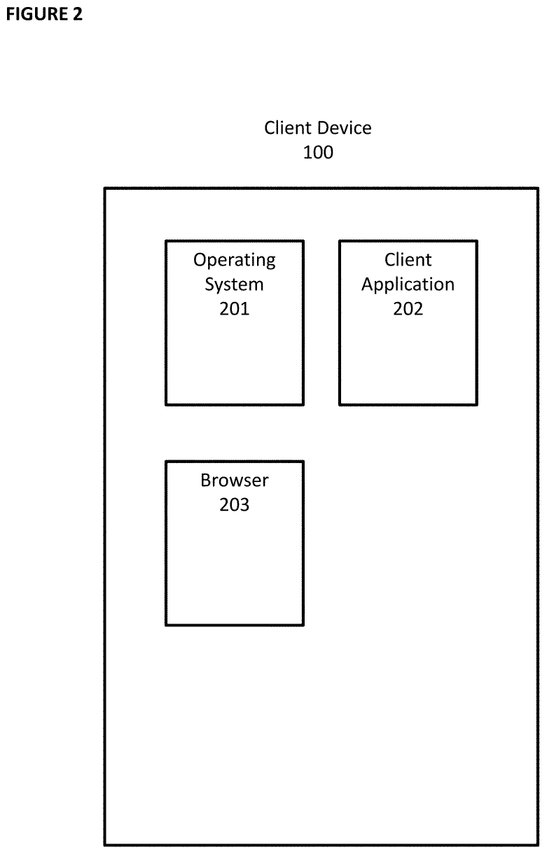

FIG. 2 depicts software components of client device 100. Client device 100 comprises operating system 201 (such as the operating systems known by the trademarks “WINDOWS,” “LINUX,” “ANDROID,” “iOS,” or others), client application 202, and browser 203. Browser 203 is a web browsing application, such as the browsers known by the trademarks “Internet Explorer,” “Chrome,” and “Safari.”

Client application 202 comprises lines of software code executed by processing unit 101 and/or graphics processing unit 107 to perform the functions described below. For example, client device 100 can be a smartphone sold with the trademark “GALAXY” by Samsung or “iPHONE” by Apple, and client application 202 can be a downloadable app installed on the smartphone or a browser running code obtained from server 300 (described below). Client device 100 also can be a notebook computer, desktop computer, game system, or other computing device, and client application 202 can be a software application running on client device 100. Client application 202 forms an important component of the inventive aspect of the embodiments described herein, and client application 202 is not known in the prior art.

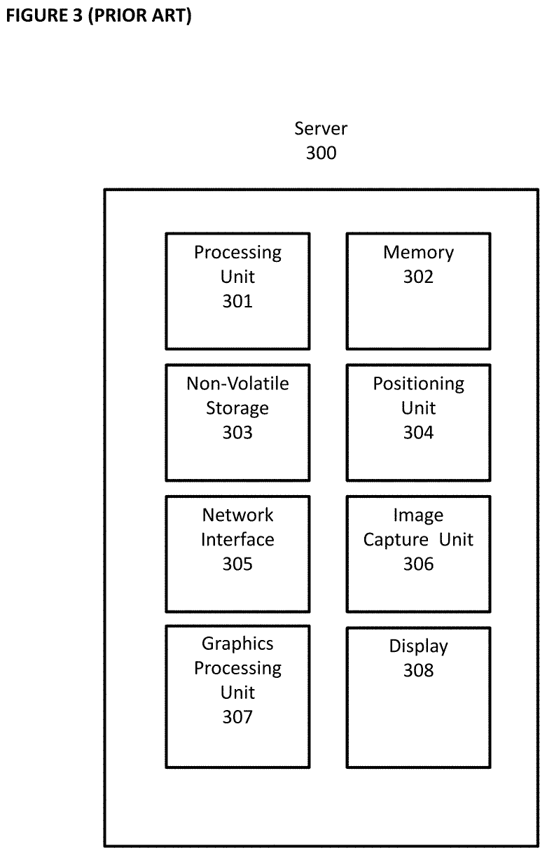

FIG. 3 depicts hardware components of server 300. These hardware components are known in the prior art and are similar or identical to the hardware components of client device 100. Server 300 is a computing device that comprises processing unit 301, memory 302, non-volatile storage 303, positioning unit 304, network interface 305, image capture unit 306, graphics processing unit 307, and display 308.

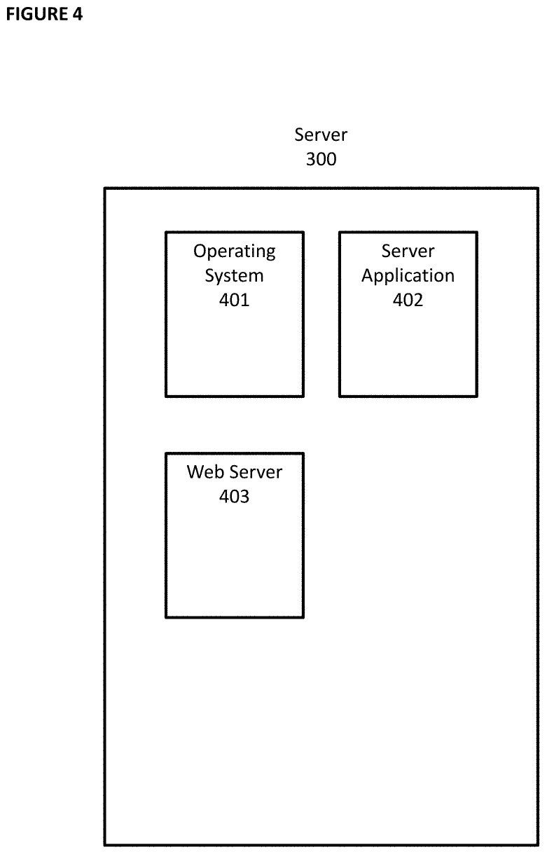

FIG. 4 depicts software components of server 300. Server 300 comprises operating system 401 (such as the operating systems known by the trademarks “WINDOWS,” “LINUX,” “ANDROID,” “iOS,” or others), server application 402, and web server 403. Web server 403 is a web page generation program capable of interacting with browser 203 on client device 100 to display web pages, such as the web server known by the trademark “APACHE.”

Server application 402 comprises lines of software code executed by processing unit 301 and/or graphics processing unit 307 to interact with client application 202 perform the functions described below.

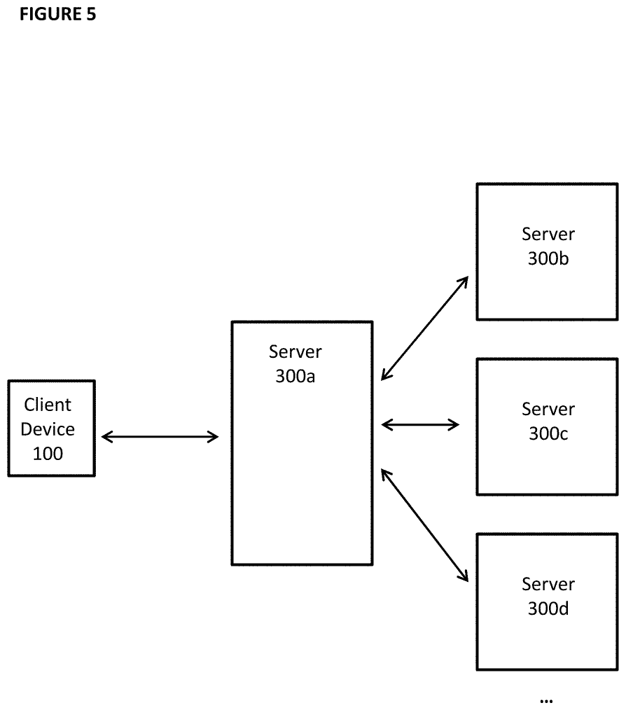

FIG. 5 depicts an example of a system according to the embodiments described herein. Client device 100 communicates with server 300a. Server 300a in turn communications with exemplary servers 300b, 300c, 300d, and others (not shown). These communications occur over the Internet or other known network or link technologies and topologies.

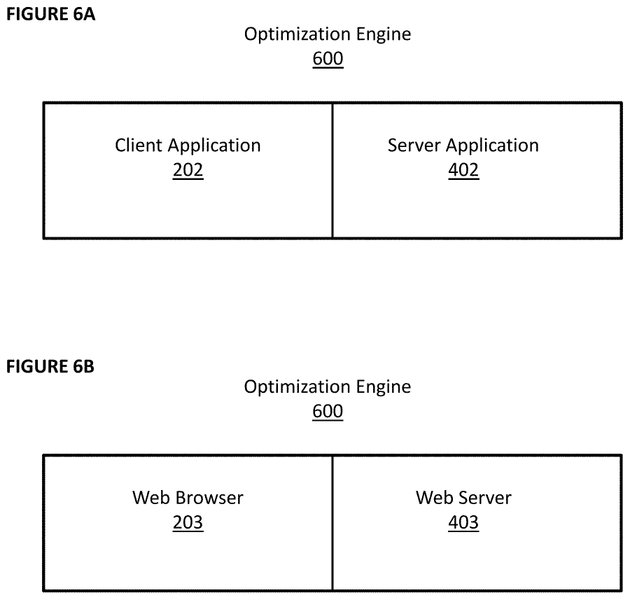

FIGS. 6A and 6B depict embodiments of optimization engine 600.

In FIG. 6A, optimization engine 600 comprises client application 202 operating in client device 100 and server application 402 operating in server 300a. The functions of optimization engine 600 are described below, and those functions can be executed by client application 202, server application 402, or both. Optimization engine 600 is utilized when an end user operates an app (i.e., client application 202) on client device 100 to engage in the functionalities described herein.

In FIG. 6B, optimization engine 600 comprises web browser 203 operating in client device 100 and web server 403 operating in server 300a. The functions of optimization engine 600 are described below, and those functions can be executed by web browser 203, web server 403, or both. Optimization engine 600 is utilized when an end user operates the web (i.e., using web browser 203) on client device 100 to engage in the functionalities described herein. The functionality provided by optimization engine 600 are substantially the same, with the main difference being the way in which the end user engages in the activity (i.e., using an app or the web).

Optimization Engine 600 and Optimization Method 700

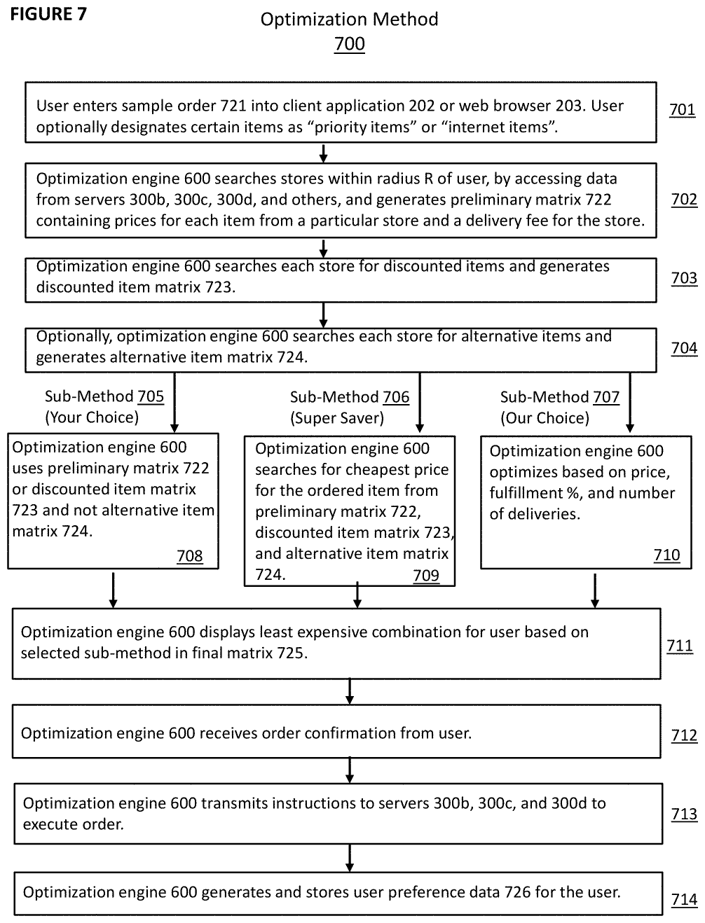

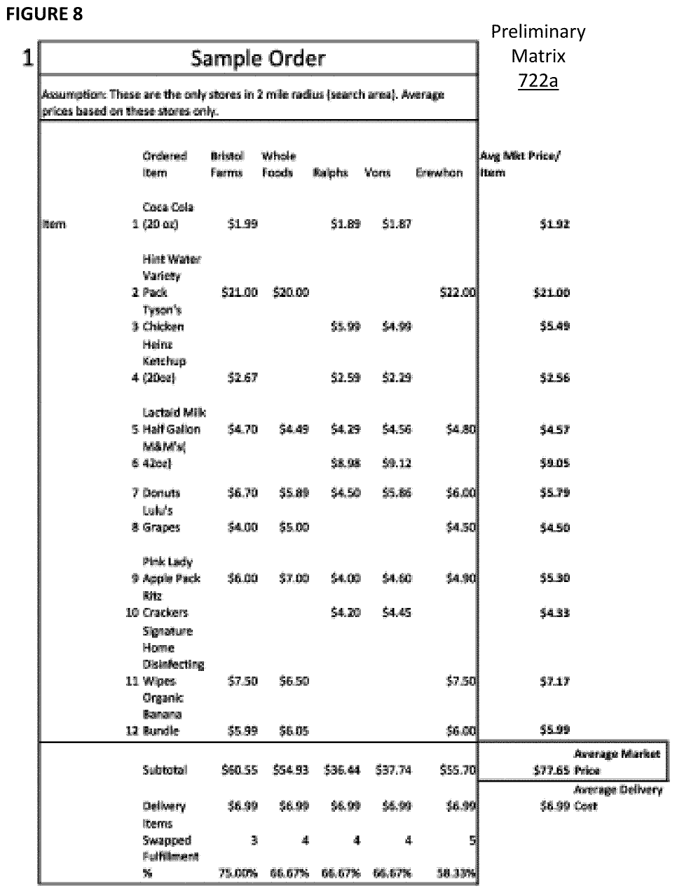

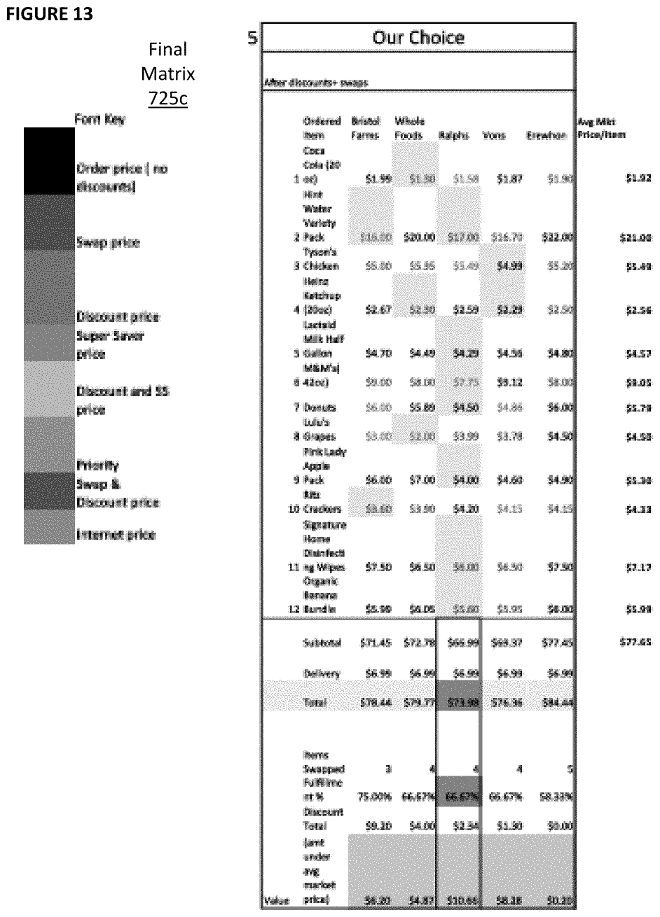

FIG. 7 depicts optimization method 700 performed by optimization engine 600. FIGS. 8-17 depict various examples of real-world applications of optimization method 700. In the particular examples shown in FIGS. 8-17, the sample order is an order for groceries and household items to be delivered from physical stores that exist near the user's physical location. This is merely one example of a practice use of optimization engine 600. Other examples include the purchase of digital content and digital content services (for example, to help a customer decide which digital streaming service to subscribe to), to help military services track and organize their spending on vendors/contractors, to help accountants/personal finance/banks/credit assistant and debt relief companies assist customers in purchasing essential items on a fixed budget, or even to help car manufacturers streamline their procurement and accurately set prices for products at certain times and/or regions.

The user's physical location can be determined using positioning unit 104 in client device 100.

As discussed below, optimization engine 300 enables a customer to create an order from all available sellers at one time, and then locate savings on each item from each seller to offset the costs of logistics and delivery. Optimization engine 300 analyzes a user's order holistically and considers the individual logistics and delivery component of each item and calculates the optimum method to deliver all items to the customer to achieve maximum savings in accordance with their specific needs. Optimization engine 300 allows a user to instantly compare all items and their respective sellers in order to make an informed purchase. The user is also informed of the exact total cost of their order with delivery costs to see what has been offset through savings. In addition to numerous attributes that the user can specify in respect to an individual item, the system will always try to seek maximum savings for the user.

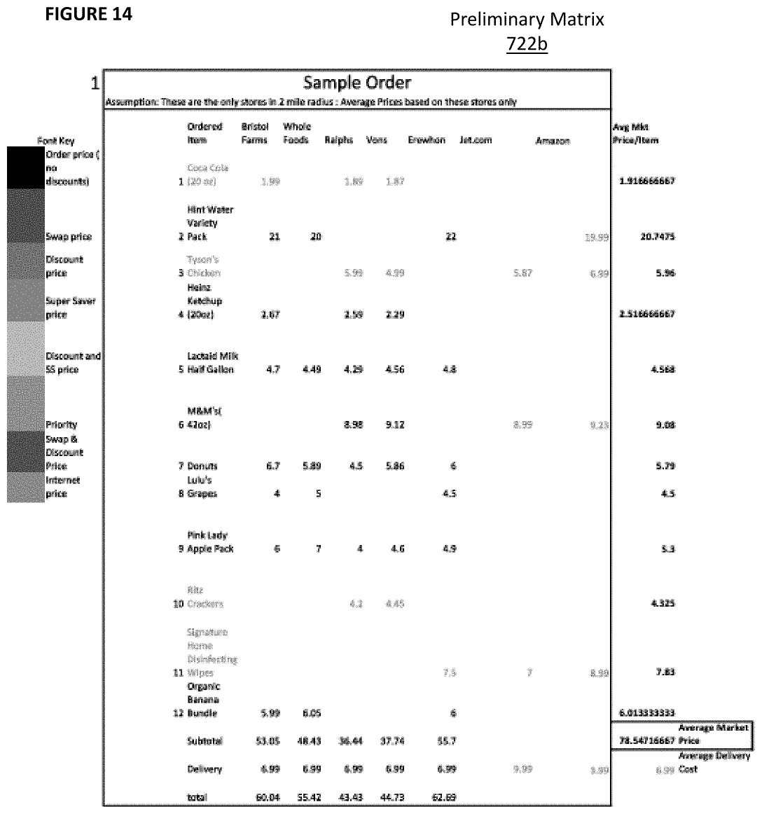

With reference to FIG. 7, a user enters sample order 721 into client application 202 or web browser 203. The user optionally designates certain items as “priority items” or “Internet items” (step 701). Additional detail regarding “priority items” and “Internet items” is contained below with reference to FIGS. 14-17.

Optimization engine 600 searches stores within radius R (e.g., 5 miles) of user's physical location, by accessing data from servers 300b, 300c, 300d, and others, and generates preliminary matrix 722 sample order 721 and populated with prices for each item that is available at each store the delivery fee for each store (step 702). FIG. 8 depicts an example of preliminary matrix 722, which depicts items entered by the user in a sample order, and item prices and delivery fees for stores within radius R. Here, each row contains an item, and each column contains prices for each store for items that it has in stock.

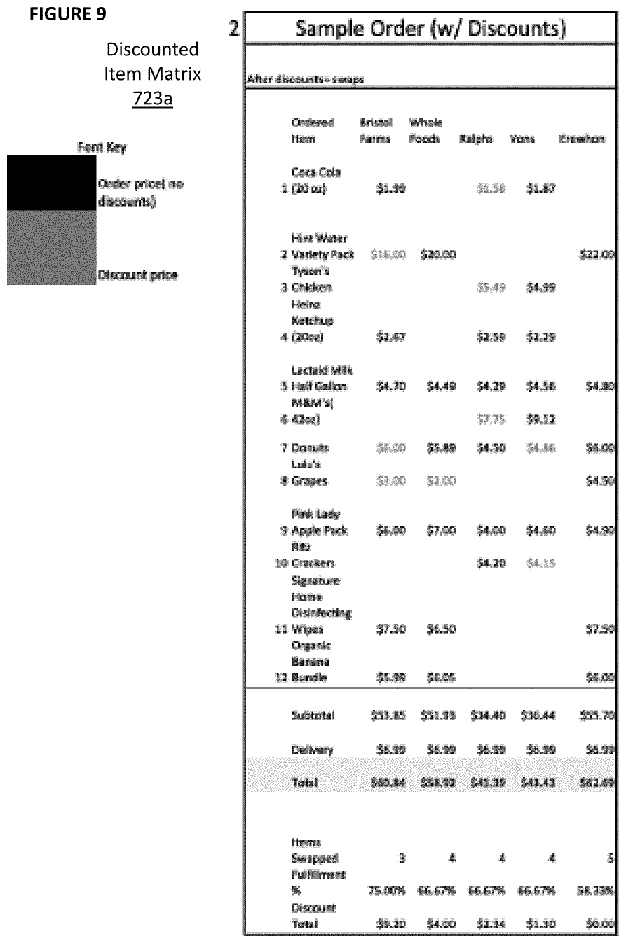

After generating preliminary matrix 722, optimization engine 600 searches each store for discounted items and updates the sample order with discounted prices it finds, to generate discounted item matrix 723 (step 703). FIG. 9 depicts an example of discounted item matrix 723, which substitutes certain prices in preliminary matrix 722 with discounted prices.

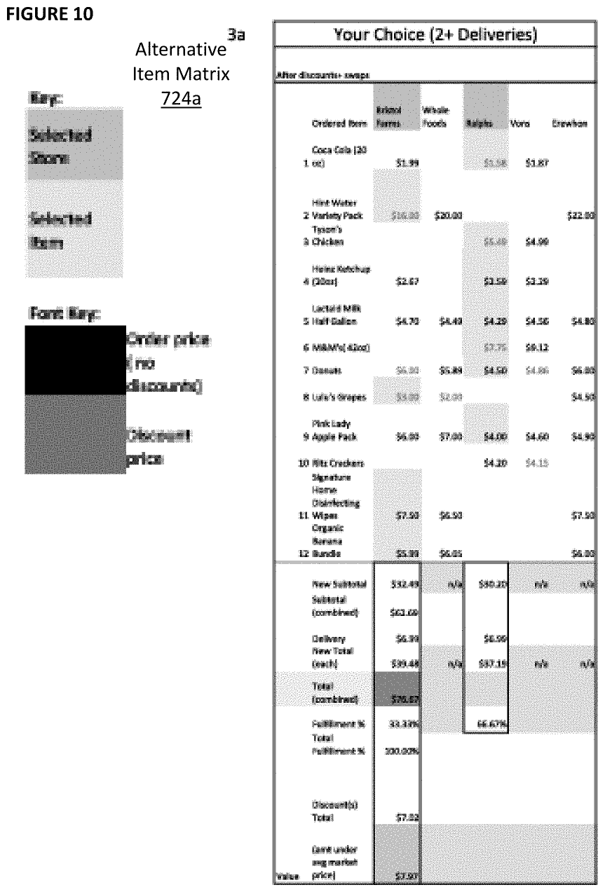

Optionally, optimization engine 600 searches each store for alternative items, and discounted item matrix 723 or preliminary matrix 722 can be updated with alternative items to generate alternative item matrix 724 (step 704). An alternative item is an item that is a substitution for an item in sample order 721 that is unavailable at a particular store. For example, one brand of cola beverage might be an alternative item for another brand of cola beverage. An alternative item can be selected by pre-loaded data available to server 300, but a user optionally can change any default alternative item to any available item of his or her choice. FIG. 10 depicts an example of alternative item matrix 724.

Optionally, the user can select different sub-methods to be performed, where each sub-method optimizes the selection of items and stores based on different criteria.

In the example shown in FIG. 7, sub-method 705 is referred to as the “Your Choice” method; sub-method 706 is referred to as the “Super Saver” method; and sub-method 707 is referred to as the “Our Choice” method.

Under sub-method 705, “Your Choice,” optimization engine satisfies the user's order by attempting to obtain 100% fulfillment—where the exact items chosen by the user in the sample order are selected—without adherence to savings or delivery efficiency (step 708). Under sub-method 705, optimization engine 300 does not swap in any alternatives. Sub-method 705 likely will require deliveries from more than one store. Under sub-method 705, users still can manually edit the items to reduce the number of deliveries or optimize the order in other ways.

Under sub-method 706, “Super Savings,” optimization engine 300 satisfies the user's order by attempting to minimize total cost—without adherence to the user's brand selection of delivery efficiency. Sub-method 706 utilizes alternatives and alternative item matrix 724 (step 709).

Under sub-method 707, “Our Choice,” optimization engine 300 aims for a “middle ground” that optimizes the overall combination of price, fulfillment percentage, and number of deliveries (step 710). Under sub-method 707, optimization engine 300 will tend to minimize the number of stores from which the items will be delivered. It does this primarily by selecting the store with the most common items and swapping outliers with relevant alternatives if applicable. Optionally, sub-method 707 utilizes machine learning to skew towards stores with a user's most preferred or consistently ordered items based on the user's preferences as determined based on previous orders.

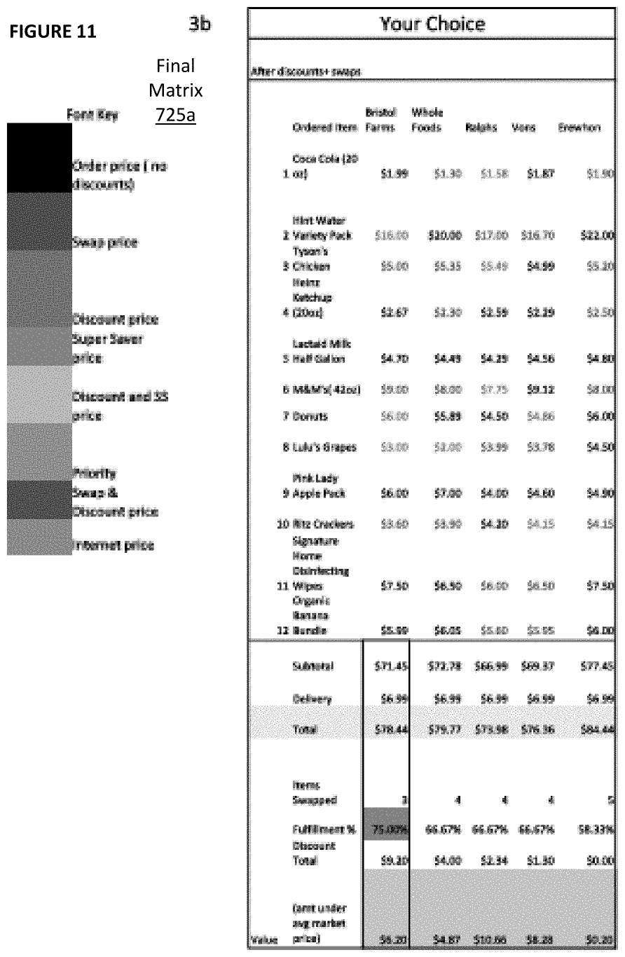

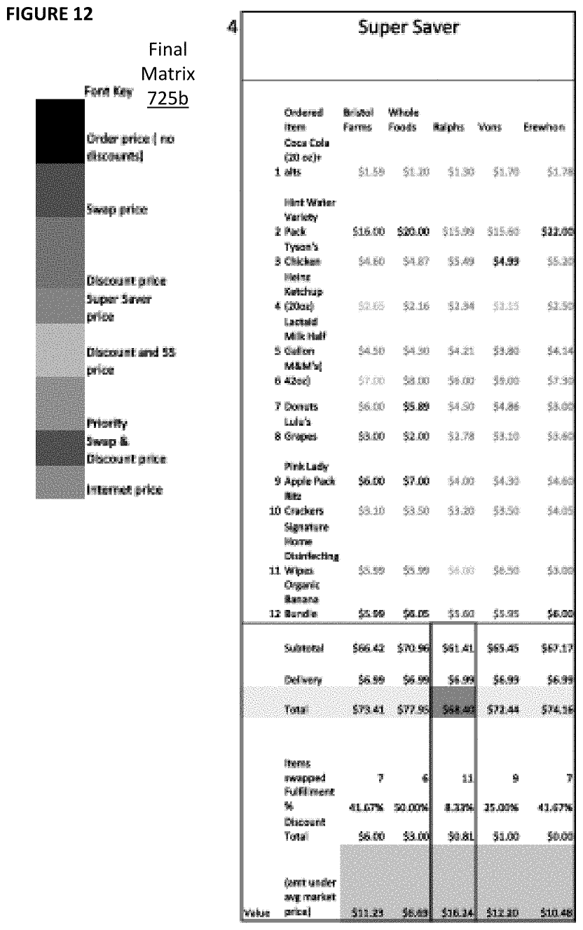

Optimization engine 600 displays the least expensive combination for user based on selected sub-method 705, 706, or 707 in final matrix 725 (step 711). FIG. 11 depicts final matrix 725a for sub-method 705. FIG. 12 depicts final matrix 725b for sub-method 706. FIG. 12 depicts final matrix 725b for sub-method 707.

After displaying final matrix 725 for the user, optimization engine 600 receives order confirmation from the user (step 712).

Optimization engine 600 then transmits instructions to servers 300b, 300c, 300d, and/or others to execute the order (step 713).

Finally, optimization engine 600 generates and stores user preference data 726 for the user (step 714).

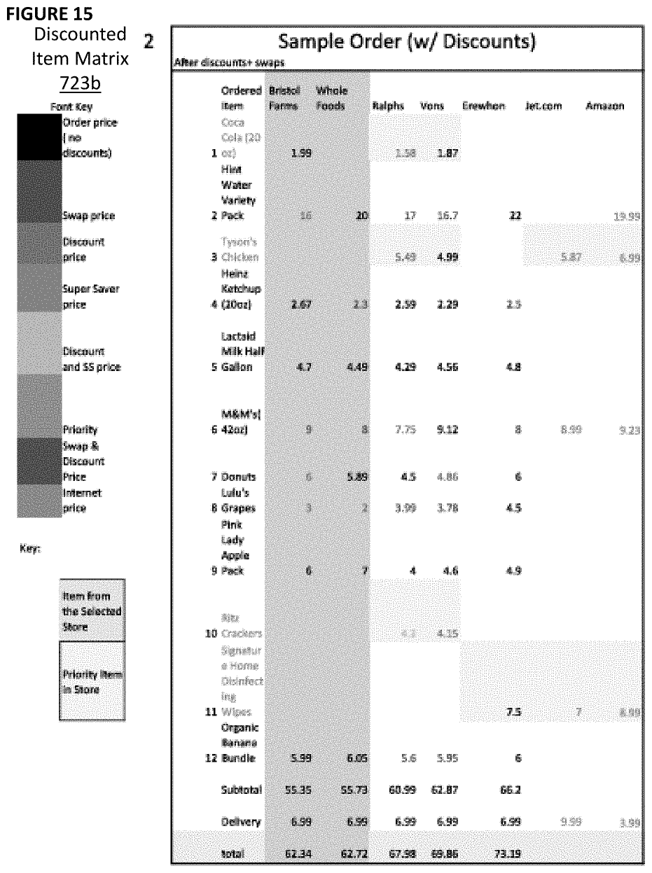

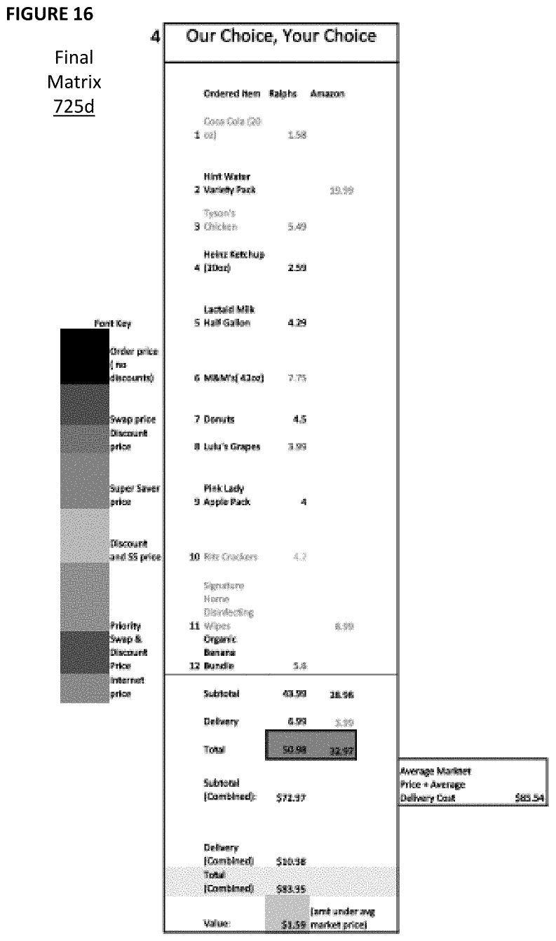

With reference to FIG. 14, a user can select an item in sample order 721 as a “priority item,” which means that the user does not want any substitutions for that item, or the user can select an item in sample order 721 as an “Internet item,” which means that the user is willing to purchase a particular item from an Internet retailer (which likely is not physically located within radius R of the user's physical location) and is willing to wait one or more days to obtain the item. Thus, FIG. 14 depicts preliminary matrix 722b, which contains some priority items and some Internet items, and which can otherwise be used in place of preliminary matrix 722a in the previous discussion. Similarly, FIG. 15 depicts discounted item matrix 723b, and FIG. 16 depicts final matrix 725d, which here is an example of a final matrix under sub-methods 705 or 707 with the use of priority and Internet items.

With reference again to FIG. 7, additional detail will now be provided for step 714 regarding the generation of user preference data 726 comprises scores generated by optimization engine 300 for the user as to brand, time, cost, and other factors. The score for the user as to brand can be based on fulfillment % from the order. If the user selected sub-method 708 (“Your Choice”) or otherwise ended up with a high fulfillment percentage, then the customer will have a high brand score because he or she has specific brand preferences and does not want one brand to be substituted for another brand. If the user selected sub-method 709 (“Super Savings”) or otherwise swapped out cheaper items for more expensive items, then the user will have a high cost score. If the user selects an on-line store (as opposed to a local store), the user will have a relatively low time score because he or she is not time sensitive.

Our optimization software focuses on multiple criteria which the user can attribute to the entire order or each item individually. Such criteria include price, brand preference, speed of delivery, products' individual attributes and origin of goods. These criteria can extend further depending on the product category and allow the user to indicate a priority ranking for each individual product.

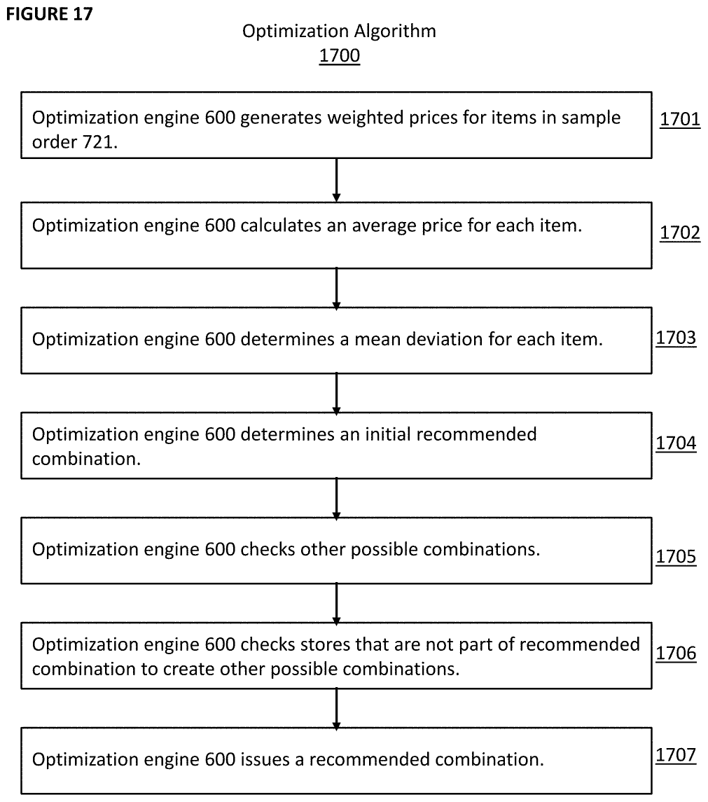

FIG. 17 depicts optimization algorithm 1700, which is performed by optimization engine 600 to perform parts of optimization method 700. Optimization algorithm 1700 minimizes a user's cost while consider other variables, such as which sub-method has been selected (e.g., Your Choice, Super Saver, Our Choice), acquisition fees, prices of items, and number of stores.

First, for each seller, optimization engine 600 determines the lowest price for each item in sample order 721 and adds to each price a weighted constant that equals the acquisition fee (e.g., delivery fee)/amount of unique positions in the store, to generate a weighted price for each item for each seller. (step 1701)

Second, optimization engine 600 calculates an average price for each item among all sellers. (step 1702)

Third, for each item, optimization engine 600 subtracts the average price from the unweighted price to obtain a mean deviation for each item. (step 1703)

Fourth, optimization engine 600 determines the best initial combination of stores to use for sample order 721. Optimization engine 600 selects a first store that is best based on average deviation and allocate all available products to that store. Optimization engine 600 then selects the remaining products from the store with the second best average deviation, and so forth, until all items are accounted for. (step 1704)

Fifth, optimization engine 600 checks other possible combinations to see if a better combination is possible. Optimization engine 600 checks each store for the best conditions (>=T items available at the store, where T is a number of items such as 11 items) and then if there are better combinations to be found. This is done by checking all products in the store in ascending order by difference of their price versus the mean price. Optimization engine 600 checks if there are any prices cheaper than the mean price. If there is a better combination, that combination then becomes the recommended combination. (step 1705)

Sixth, optimization engine 600 checks all other stores that were not part of the recommended combination. Optimization engine 600 checks if some of their products cover the delivery fee. Optimization engine 600 also checks if there are better conditions (e.g., more items available) for that store. If a better combination is found, it becomes the recommended combination. If the result has a few stores, compare the product prices by pairs and try to get cheaper solution by it. (step 1706).

Finally, optimization engine 600 outputs the recommended combination, and steps are then taken to fulfill the order according to the recommended combination. (step 1707).

A person of ordinary skill in the art will appreciate that optimization engine 600 can be used to perform optimizations in numerous other scenarios involving physical goods and services or digital goods and services, and that the embodiments described above are mere examples of possible uses cases.

What is claimed is:

1. A method for optimizing an order for goods, comprising:
obtaining, from a user, an order comprising a list of goods;
generating a preliminary matrix comprising preliminary prices for the goods in the list of goods and delivery fees from a plurality of retailers whose physical distance to the user is below a predetermined threshold;
generating a discounted item matrix based on the preliminary matrix by changing one or more preliminary prices to discounted prices from one or more of the plurality of retailers;
performing optimizations to modify the discounted item matrix into a final matrix, where the optimizations comprise one or more optimizations based on cost, brand, or delivery time
receiving confirmation from the user for the final matrix; and
executing an order for the goods in the final matrix.

2. The method of claim 1, further comprising:
entering, by the user, obtaining, the order comprising a list of goods into an app in a smartphone.

3. The method of claim 1, further comprising:
entering, by the user, obtaining, the order comprising a list of goods into a web browser.

4. The method of claim 1, further comprising:
obtaining, by a first server, the preliminary prices from one or more other servers.

5. The method of claim 1, further comprising:
obtaining, by a first server, the discounted prices from one or more other servers.

6. The method of claim 1, further comprising:
displaying the final matrix on a display of a client device.

7. The method of claim 1, further comprising:
generating user preference data for the user based on one or more of the preliminary matrix and the final matrix.

8. A method for optimizing an order for goods, comprising:
obtaining, from a user, an order comprising a list of goods;
generating a preliminary matrix comprising preliminary prices for the goods in the list of goods and delivery fees from one or more local retailers whose physical distance to the user is below a predetermined threshold and one or more Internet retailers;
generating a discounted item matrix based on the preliminary matrix by changing one or more preliminary prices to discounted prices from the one or more local retailers and the one or more Internet retailers;
performing optimizations to modify the discounted item matrix into a final matrix, where the optimizations comprise one or more optimizations based on cost, brand, or delivery time
receiving confirmation from the user for the final matrix; and
executing an order for the goods in the final matrix from one or more of the local retailers and Internet retailers.

9. The method of claim 8, further comprising:
entering, by the user, obtaining, the order comprising a list of goods into an app in a smartphone.

10. The method of claim 8, further comprising:
entering, by the user, obtaining, the order comprising a list of goods into a web browser.

11. The method of claim 8, further comprising:
obtaining, by a first server, the preliminary prices from one or more other servers.

12. The method of claim 8, further comprising:
obtaining, by a first server, the discounted prices from one or more other servers.

13. The method of claim 8, further comprising:
displaying the final matrix on a display of a client device.

14. The method of claim 8, further comprising:
generating user preference data for the user based on one or more of the preliminary matrix and the final matrix.

15. A method for optimizing an order for goods, comprising:
obtaining, from a user, an order comprising a list of goods;
generating a preliminary matrix comprising preliminary prices for the goods in the list of goods and delivery fees from a plurality of retailers whose physical distance to the user is below a predetermined threshold;
generating a discounted item matrix based on the preliminary matrix by changing one or more preliminary prices to discounted prices from one or more of the plurality of retailers;
generating an alternative item matrix based on the discounted item matrix where one or more items in the list of goods are replaced with an alternative item;
performing optimizations to modify the alternative item matrix into a final matrix, where the optimizations comprise one or more optimizations based on cost, brand, or delivery time
receiving confirmation from the user for the final matrix; and
executing an order for the goods in the final matrix.

16. The method of claim 15, further comprising:
entering, by the user, obtaining, the order comprising a list of goods into an app in a smartphone.

17. The method of claim 15, further comprising:
entering, by the user, obtaining, the order comprising a list of goods into a web browser.

18. The method of claim 15, further comprising:
obtaining, by a first server, the preliminary prices from one or more other servers.

19. The method of claim 15, further comprising:
obtaining, by a first server, the discounted prices from one or more other servers.

20. The method of claim 15, further comprising:
displaying the final matrix on a display of a client device.

21. The method of claim 15, further comprising:
generating user preference data for the user based on one or more of the preliminary matrix and the final matrix.
